(19) United States
(12) Patent Application Publication
(10) Pub. No.: US 2005/0042470 A1
(43) Pub. Date: Feb. 24, 2005

(54) Cellulose ester based products and methods for making them

(76) Inventors: John William Vogler, Chesterfield, VA (US); Larry Wayne Renfro, Kingsport, TN (US); David Lee Larkins, Kingsport, TN (US); David Gearl Douthat, Kingsport, TN (US)

Correspondence Address: Charles R. Richard;Eastman Chemical Company, P.O. Box 511, Kingsport, TN, 37662-5075, US

(21) Appl. No.: 10/646,483

(22) Filed: Aug. 22, 2003

(51) Int. Cl. B32B 23/04

(52) U.S. Cl. 428/536; 156/308.6

(57) ABSTRACT

The present invention provides a method of adhering two or more components together by exposing a first component that includes cellulose ester fibers and/or a second component that includes a cellulose ester to a plasticizing solvent. The two components are then contacted together form a compound structure which is subsequently allowed to cure so that the two components are bonded together. The present invention is advantageously utilized to form a filter and in particular a cigarette filter and to form a multilayer automobile headliner. The present invention also provides a method of adhering a cellulose ester-containing automobile headliner to a vehicle passenger compartment ceiling. In this embodiment, a cellulose ester-containing composition is applied to the vehicle compartment ceiling prior to attachment of the headliner. The headliner and/or the vehicle passenger compartment ceiling are then exposed to a plasticizing solvent, contacted together, and then cured thereby adhering the headliner.

### BACKGROUND OF THE INVENTION

1. Field of the Invention

The present invention is related to methods of adhering a fibrous cellulose ester-containing component to a second cellulose ester-containing component, and in particular, to a method of adhering cellulose acetate tow to a paper to form a cigarette filter.

2. Background Art

Cellulose acetate is derived from purified cellulose. Cellulose acetate possesses a number of characteristics that make it desirable in such diverse industrial applications as the manufacturing of apparel, papers, liners, draperies, upholstery, and filters, such as for cigarettes. Such characteristics include, for example, softness, relatively fast dryability, shrink resistance, mildew resistance, and the ability to remove some components from a gaseous stream.

Cellulose acetate can be made by reacting purified cellulose with acetic acid and acetic anhydride in the presence of a mineral acid such as sulfuric acid. Subsequently, the resulting material is purified by hydrolysis to remove the mineral acid and to adjust the number of acetate groups to tailor the physical properties of the cellulose acetate. The repeating monomer in cellulose is the anhydroglucose unit which has three hydroxyl groups. In the typical form of cellulose acetate about two of the three hydroxyl groups on average will be acetylated. In a subsequent step, the cellulose acetate, still considered to be in a crude form, is typically dissolved in a solvent and extruded in a spinneret to produce the cellulose acetate fibers. These fibers may be gathered into bundles and crimped to form cellulose acetate tow which is then dried and baled.

In the manufacture of cigarette filter rods, cellulose acetate tow is processed using a machine called a plugmaker. The plugmaker takes a band of cellulose acetate fibers from a bale and passes it though a series of air jets and driven rolls to bloom and relax the band of fibers. The plugmaker then passes the band of fibers through a spray application of plasticizing solvent and forms a bundle of fibers into a cylindrical shape. A plasticizing solvent is applied to the bundle to cause the cellulose acetate fibers to bond to one another resulting in an acceptably firm cellulose acetate rod. The cellulose acetate tow is subsequently wrapped with a paper, known as plugwrap, to assist the filter rod in retaining its shape and for ease of processing.

Typically, the plugwrap is held to the bundle of fibers with the aid of one or more lines of glue. The glue is usually applied to the paper by the plugmaking machine before it wraps the fiber bundle. Although the prior art methods of making cigarette filters works reasonably well, glue lines often cause a number of problems. For example, leakage of the glue through the paper may cause the filter rods to jam during transport through pneumatic conveyor lines after the plugmaker equipment. Glue lines can also obstruct the desired ventilation in porous plugwrap paper in the finished product thereby altering the ventilation pattern. Finally, the lack of symmetry in glue lines induces retraction forces as the tow relaxes in the rod causing the rod to bend and wrinkle.

Cellulose acetate may also be utilized in the fabrication of automobile headliners. Automotive headliners are used to line the ceiling of the passenger compartment of an automobile. The typical headliner is a multilayer structure having one or more foam layers and one or more fiber-containing layers (usually glass fiber-containing layers.) Multilayer headliners often require discrete adhesive layers to hold the layers together. A popular type of headliner includes a decorative fabric, a thin soft flexible foam layer disposed over the fabric, a urethane film layer disposed over the foam layer, and finally a rigid polyurethane foam layer disposed over the urethane film layer. In another headliner design, a foamed polyurethane layer is sandwiched between two glass fiber-containing matts. A decorative fabric layer is disposed over at least one of these matts to provide the visible surface of the headliner when it is attached to a vehicle interior. U.S. Pat. No. 4,121,960 discloses a “film-to-foam” laminate suitable for headliner applications in which a film layer that may contain cellulose acetate is adhered to a foam layer. The foam layer disclosed in the '960 patent is an open cell foam material such as foam type thermoplastic resins and foam type elastomers. The '960 patent states that this laminate is useful as a sound adsorbing layer in an automobile headliner. These automobile headliners are typically attached to vehicle passenger compartments by tedious mechanical processes such as stapling and tacking.

Accordingly, there exists a need for an improved process of making filters, and in particular cigarette filters, in which glue does not leak through the paper and in which the rod does not bend and create wrinkles. Similarly, there is also a need for improved methods of adhering layers in a headliner together, as well as, improved methods of attaching headliners to a vehicle passenger compartment.

### SUMMARY OF THE INVENTION

The present invention provides a method of adhering two or more components together. In at least one embodiment, the method of the invention comprises exposing at least one of a first component that includes cellulose ester fibers and a second component that includes a cellulose ester to a plasticizing solvent, contacting the first component and the second component together to form a compound structure, and then subsequently allowing the compound structure to cure so that the first component and the second component become adhered together. The method of the invention is advantageously used to make filters in which a fibrous component is adhered to a substrate. In a particularly useful application, a cigarette filter is made by adhering plug-wrap paper containing a cellulose ester to a cellulose ester containing tow. The present invention eliminates the need for a separate glue line to adhere the plugwrap to the filter rod.

In another embodiment of the present invention, a method of adhering an automobile headliner to the ceiling of a vehicle passenger compartment is provided. In this variation, cellulose ester fibers are incorporated into a surface layer of an automobile headliner. The layer in which the fibers are incorporated is the layer which opposes the ceiling of the passenger compartment when the headliner is installed. The method further comprises coating the vehicle compartment ceiling with a cellulose ester-containing composition to form a coated vehicle compartment ceiling. A plasticizing solvent is then applied to one or both of the surface layer of the headliner or the coated vehicle compartment ceiling to form a compound headliner-ceiling structure. Finally, the headliner-ceiling structure is cured to form a passenger compartment ceiling with an adhered headliner.

In another embodiment of the invention, a method of making an automobile headliner made is provided. The method of this embodiment comprises incorporating cellulose ester into a first layer and a second layer of a multilayer automobile headliner. A plasticizing solvent is then exposed to one or both of the first layer or the second layer. The first and second layer are then contacted together to form a headliner bilayer. Next, the headliner bilayer is cured to form a cured headliner bilayer in which the first layer and the second layer are adhered together. The method of the present embodiment may be repeated and used to adhere each layer of a multilayer headliner together.

In yet another embodiment of the present invention, the method of the invention is used to make a filter and in particular a cigarette filter. The filter of this embodiment comprises an aggregation of cellulose ester fibers, a cellulose ester-containing substrate disposed over the aggregation of cellulose ester fibers, and a solvent bond between the aggregation of cellulose ester fibers and the cellulose ester-containing substrate that adheres the aggregation of cellulose ester fibers and the cellulose ester-containing substrate together. The solvent bond of this embodiment is formed by applying a plasticizing solvent to one or both of a surface of the aggregation of cellulose ester fibers or a surface of the cellulose ester-containing substrate.

In still another embodiment of the invention, an automobile headliner made by the method of the invention is provided. The headliner of this embodiment comprises a first layer containing cellulose acetate, a second layer containing cellulose acetate, and a solvent bond that adheres the first and second layers together. The solvent bond of this embodiment is formed by applying a plasticizing solvent to a surface of one or both of the first layer or the second layer.

### DETAILED DESCRIPTION OF THE INVENTION

Reference will now be made in detail to presently preferred compositions or embodiments and methods of the invention, which constitute the best modes of practicing the invention presently known to the inventors.

As used herein, “cellulose” refers to a naturally occurring polysaccharide that consists of glucose units. Cellulose is found in many plants and in particular, woods, jute, flax, hemp, and the like.

As used herein, “solvent bonding” refers to a process of adhering two or more components together by applying a solvent to one or more of the surfaces of such components and pressing the components together. Adhesion occurs by one or more of the following mechanisms: absorption of solvent into the material surfaces and/or solvent evaporation.

As used herein, “solvent bond” refers to a bond that adheres two or more components together by solvent bonding. Such a bond is formed by one or more of the following mechanisms: absorption of solvent into the material surfaces and/or solvent evaporation.

As used herein, “plasticizing solvent” refers to a solvent that imparts flexibility, workablilty, and elongation when added to a material such as a polymer.

As used herein, “curing” refers to allowing formation of a solvent bond by a mechanism such as adsorption and/or evaporation. Curing may optionally be assisted by heating.

In an embodiment of the present invention, a method of adhering two or more components together is provided. The method of the invention comprises exposing at least one of a first component that includes cellulose ester fibers and a second component that includes a cellulose ester to a plasticizing solvent and then contacting the first component and the second component together to form a compound structure of the first and second components. The compound structure is allowed to cure so that the first component and the second component become adhered together.

Suitable cellulose ester fibers that may be utilized in practicing the invention include, for example, fibers comprising a component selected from the group consisting of cellulose acetate, cellulose propionate, cellulose butyrate, cellulose acetate-propionate, cellulose acetate-butyrate, cellulose propionate-butyrate, and mixtures thereof. Cellulose ester fibers comprising cellulose acetate are particularly preferred.

Similarly, the second component also includes a cellulose ester that may be selected the group consisting of cellulose acetate, cellulose propionate, cellulose butyrate, cellulose acetate-propionate, cellulose acetate-butyrate, cellulose propionate-butyrate, and mixtures thereof. Preferably the second component comprises cellulose acetate.

Advantageously, this second component that includes a cellulose ester is a paper which may optionally further include cellulose.

A number of different types of plasticizing solvents may be used in practicing the method of the invention. Such plasticizing solvents must be capable of at least partially softening the cellulose ester in the first and second components so that a solvent bond can be formed. Suitable solvents include a solvent selected from the group consisting of dimethoxy ethyl phthalate, triacetin (glycerol triacetate or GTA), polyethylene glycol (various molecular weights), triethylene glycol diactetate, diethylene glycol diacetate, diethylene glycol dipropionate, diethylene glycol acetate propionate, diethylene glycol monopropionate, and mixtures thereof. The plasticizing solvents may be applied to one or both of the first and second components by a number of techniques known to one skilled in the art. Such techniques include, but are not limited to, spraying, dipping, brushing, or a combination thereof. Moreover, the plasticizing solvent may be applied such that the first and second components are coated with a continuous solvent coating or the solvent may be applied to one or both of the components in a pattern such as a series of dots or lines. The level of plasticizer to be used should be enough to effect the desired functionality of holding the filter in place inside of the plugwrap, while still maintaining the properties traditionally associated with the application of plasticizer.

In another embodiment of the present invention, a method of making a filter is provided. The method of this embodiment comprises exposing an aggregation of cellulose ester fibers to a plasticizing solvent to form a solvent-containing aggregation of cellulose ester-containing fibers. The cellulose ester-containing aggregation of fibers are then contacted with a cellulose ester-containing substrate to form a compound structure of the aggregation of fibers and the substrate. The compound structure is allowed to cure so that substrate is adhered to the aggregation of cellulose ester fibers. Optionally, prior to the step of contacting the aggregation of fibers to the cellulose ester-containing substrate, either the aggregation of fibers, the cellulose ester-containing substrate, or both the aggregation of fibers and the substrate are exposed to one or more additional applications of the same or a different solvent. Again, as set forth above, the further additional solvent application(s) may be applied by a number of techniques, which include for example, spraying, dipping, brushing, or a combination thereof. The method of this embodiment may be used to form any filter in which a fibrous filter component is adhered to a substrate. Such filters include, for example, air filters used in heating and cooling systems and cigarette filters. Suitable substrates include, for example, paper. This substrate is particularly useful when the final product of the process is a cigarette filter. In this particular application of the invention, the step of contacting the aggregation of cellulose ester fibers with a substrate comprises wrapping (which includes covering either in whole or in part) the aggregation of cellulose ester fibers with the substrate. Accordingly, the cellulose ester-containing substrate comprises a component selected from the group consisting of cellulose acetate, cellulose propionate, cellulose butyrate, cellulose acetate-propionate, cellulose acetate-butyrate, cellulose propionate-butyrate, and mixtures thereof. In particular, the cellulose ester-containing substrate comprises cellulose acetate.

In the preferred cigarette filter applications, a plug-wrap paper containing a cellulose ester is adhered to a cellulose ester-containing tow. The preferred cellulose ester in the paper and the tow is cellulose acetate. The cellulose ester in the plug-wrap may be in the form of fiber in the paper or in the form of a coating or film on the surface of the paper. In either case, the amount of cellulose ester used will depend on the amount of adhesiveness desired. In the case of the plugwrap example, the appropriate amount of cellulose ester will be a sufficient amount to adhere the filter rod to the plugwrap during the processing of the filter rod, and to resist extraction from the plugwrap by reasonable mechanical force. The method of the present invention advantageously provides adhesion around the perimeter of the tow nearly evenly thereby reducing the problem of rod wrinkling. Moreover, the maintenance, clean-up, and raw materials costs associated with using glue lines is eliminated. Plugwrap paper manufactured with the appropriate percentage of cellulose ester fibers can be used on a traditional plugmaking machine to make rods that would be adhered to the plugwrap through the bonding action of the plasticizer.

It should be appreciated that a dry cellulose acetate tow does not anchor itself to a plugwrap paper containing any amount of cellulose acetate fibers without the action of a bonding plasticizer, such as triacetin (glycol triacetate or GTA). Similarly, a cellulose acetate tow will not adhere to conventional plugwrap paper using a bonding plasticizer alone without the inclusion of a cellulose ester being present in or on the plugwrap. Moreover, it is known that cellulose ester fibers, and in particular cellulose acetate fibers, can be used to make a sheet-like web or can also be used as a component in paper. Accordingly, when the second component is a paper, a cellulose ester can be incorporated into the paper during the paper forming process. Alternatively, a paper can be over-coated with a layer of the cellulose ester either continuously or in a pattern. A paper made in this manner may be solvent bonded to a filter tow by the methods set forth above.

In another embodiment of the present invention, a method of adhering an automobile headliner to the ceiling of a vehicle passenger compartment is provided. In this variation, cellulose ester fibers are incorporated into a surface layer of an automobile headliner. The layer in which the fibers are incorporated is the layer of the headliner which opposes the ceiling of the passenger compartment when the headliner is installed. The method of this embodiment comprises applying a cellulose ester-containing composition to the vehicle compartment ceiling to form a coated vehicle compartment ceiling. One or both of the surface layer or the coated vehicle compartment ceiling are then exposed to a plasticizing solvent. The surface layer and the coated vehicle compartment ceiling are contacted together to form a compound headliner-ceiling structure. Finally, the compound headliner-ceiling structure is cured so that the surface layer and the coated vehicle compartment ceiling become adhered together. The cellulose ester-containing composition that is applied to the vehicle passenger compartment ceiling comprises a cellulose ester and a solvent. The cellulose ester is at least partially soluble in the solvent. Suitable solvents include, for example, ethyl acetate, butyl acetate, acetone, and ethanol. The cellulose ester fibers that are incorporated in the surface layer preferably comprise a component selected from the group consisting of cellulose acetate, cellulose propionate, cellulose butyrate, cellulose acetate-propionate, cellulose acetate-butyrate, cellulose propionate-butyrate, and mixtures thereof. Similarly, the cellulose ester-containing composition comprises a component selected from the group consisting of cellulose acetate, cellulose propionate, cellulose butyrate, cellulose acetate-propionate, cellulose acetate-butyrate, cellulose propionate-butyrate, and mixtures thereof. More preferably, both the cellulose ester fiber and the cellulose ester-containing composition independently comprise cellulose acetate.

In another embodiment of the invention, a method of making an automobile headliner made is provided. The method of this embodiment comprises incorporating cellulose ester into a first layer and a second layer of a multilayer automobile headliner. Preferably, one or both of the first layer and the second layer will comprise cellulose ester fibers. A plasticizing solvent is then exposed to one or both of the first layer or the second layer. The first and second layer are then contacted together to form a headliner bilayer. Next, the headliner bilayer is cured to form a cured headliner bilayer in which the first layer and the second layer are adhered together. The method of the present embodiment may be repeated used to adhere each layer of a multilayer headliner together. As set forth above, a typical automobile headliner may include a decorative fabric layer, one or more foamed layer, and one or more glass fiber-containing layers. A cellulose ester, preferably in the form of cellulose ester fibers, is incorporated into at least two adjacent layers when practicing the method of the present embodiment. The selection of the cellulose esters used in this embodiment as well as the plasticizing solvents is the same as set forth above.

In yet another embodiment of the present invention, a filter made by the methods set forth above is provided. The filter of the invention comprises an aggregation of cellulose ester fibers, a cellulose ester-containing substrate disposed over the aggregation of cellulose ester fibers, and a solvent bond between the aggregation of cellulose ester fibers and the cellulose ester-containing substrate that adheres the aggregation of cellulose ester fibers and the cellulose ester-containing substrate together. Although not limiting the present embodiment to any particular mode of operation, it is believed that the solvent bond is formed by absorption of a solvent into one or both of a surface of the aggregation of cellulose ester fibers or a surface of the cellulose ester-containing substrate. An alternative mechanism by which the solvent bond is formed is by evaporation of a solvent applied to one or both of the aggregation of cellulose ester fibers or the cellulose ester-containing substrate. The filters embodiment are any filters in which a fibrous filtering component is attached to a substrate. Examples include air filters used in heating and cooling systems and cigarette filters. A preferred filter of the present embodiment is a cigarette filter. In these filter applications, the aggregation of cellulose ester fibers preferably comprises a component selected from the group consisting of cellulose acetate, cellulose propionate, cellulose butyrate, cellulose acetate-propionate, cellulose acetate-butyrate, cellulose propionate-butyrate, and mixtures thereof. The cellulose ester-containing substrate may comprise a component selected from the group consisting of cellulose acetate, cellulose propionate, cellulose butyrate, cellulose acetate-propionate, cellulose acetate-butyrate, cellulose propionate-butyrate, and mixtures thereof. The substrate will most preferably comprise cellulose acetate and/or may further comprise cellulose. A preferred cellulose ester-containing substrate is a paper which may have one or more of the above characteristics.

In still another embodiment of the invention, an automobile headliner made by the method of the invention is provided. The headliner of this embodiment comprises a first layer containing a cellulose ester, a second layer containing a cellulose ester, and a solvent bond that adheres the first and second layers together. Preferably, the first layer contains cellulose ester fibers. The solvent bond of this embodiment is formed by applying a plasticizing solvent to a surface of one or both of the first layer or the second layer. The selection of the cellulose ester in the first and second layers and the plasticizing solvent is the same as those set forth above. Preferably, both the first and second layers comprise cellulose acetate.

The following examples illustrate the various embodiments of the present invention. Those skilled in the art will recognize many variations that are within the spirit of the present invention and scope of the claims.

### EXAMPLE 1

A thin film of cellulose acetate was cast onto a glass plate. This film was of about five-mil thickness. Previously made filter rods were slit open, and the plugwrap paper was removed. The rods were then sprayed with a small amount of triacetin using an aerosol sprayer. These rods were placed onto the cellulose acetate film that was cast on the glass plate, and allowed to cure for one hour. After 1 hour the rods were checked and found to have adhered to the film.

### EXAMPLE 2

In a similar experiment to Example 1, a length of plugwrap paper was taped to a glass plate, and a thin film of cellulose acetate was cast onto the paper. Previously made filter rods were stripped of their plugwrap, and sprayed with a small amount of triacetin using an aerosol sprayer. These rods were placed onto the paper strip and allowed to cure for one hour. The rods were then checked and found to have adhered to the coated plugwrap paper.

### EXAMPLE 3

A length of plugwrap paper was taped by its ends to a glass plate, and a covered with two additional pieces of paper such that a 4 mm wide strip down the center of the paper remained visible. A five-ml film of cellulose acetate was then cast such that it covered the visible strip. The two pieces of paper forming the template were immediately removed leaving a length of plugwrap having a 4 mm cellulose acetate strip down the center. Previously made rods were then stripped of their plugwrap paper and sprayed with a small amount of triacetin using an aerosol sprayer. The treated paper was wrapped lengthwise around the rods. The wrapped rods were placed into a small tube of the appropriate diameter to cure. After approximately one hour of curing time, the rods were checked and found to have adhered to the strip of treated paper.

### EXAMPLE 4

A length of plugwrap is taped to a glass plate as set forth in Example 3 and overlaid with a paper template. Small circular holes are punched in the template. A thin film of cellulose acetate is cast over the template and the template removed, leaving only a series of circular dots of cellulose acetate film on the plugwrap paper. A pre-made rod is then sprayed with triacetin aerosol, and attached to the paper.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method of adhering two or more components together, the method comprising:
a) exposing at least one of a first component that includes cellulose ester fibers and a second component that includes a cellulose ester to a plasticizing solvent;
b) contacting the first component and the second component together to form a compound structure; and
c) curing the compound structure so that the first component and the second component become adhered together.

2. The method of claim 1 wherein the cellulose ester fibers comprise a component selected from the group consisting of cellulose acetate, cellulose propionate, cellulose butyrate, cellulose acetate-propionate, cellulose acetate-butyrate, cellulose propionate-butyrate, and mixtures thereof.

3. The method of claim 1 wherein the cellulose ester fibers comprise cellulose acetate.

4. The method of claim 1 wherein the second component comprises a component selected from the group consisting of cellulose acetate, cellulose propionate, cellulose butyrate, cellulose acetate-propionate, cellulose acetate-butyrate, cellulose propionate-butyrate, and mixtures thereof.

5. The method of claim 4 wherein the second component comprises cellulose acetate.

6. The method of claim 1 wherein the second component is a paper.

7. The method of claim 6 wherein the second component further comprises cellulose.

8. The method of claim 1 wherein the plasticizing solvent is selected from the group consisting of dimethoxy ethyl phthalate, triacetin, polyethylene glycol, triethylene glycol diactetate, diethylene glycol diacetate, diethylene glycol dipropionate, dethylene glycol acetate propionate, diethylene glycol monopropionate, and mixtures thereof.

9. The method of claim 1 wherein the step of exposing at least one of the components to a plasticizing solvent comprises spraying, dipping, brushing, or a combination thereof.

10. The method of claim 1 wherein the first component is a first layer of a multilayer automobile headliner and the second component is a second layer of a multilayer headliner.

11. The method of claim 1 wherein the first component is adhered to the second component to form a filter.

12. A method of making a filter, the method comprising:
a) exposing an aggregation of cellulose ester fibers to a plasticizing solvent;
b) contacting the aggregation of cellulose ester fibers exposed to the plasticizing solvent with a cellulose ester-containing substrate; and
c) curing the aggregation of cellulose ester fibers contacted to the substrate so that the substrate is adhered to the aggregation of cellulose ester fibers.

13. The method of claim 12 wherein prior to step b, either the aggregation of fibers, the cellulose ester-containing substrate, or both the aggregation of fibers and the substrate are exposed to one or more additional applications of the same or a different solvent.

14. The method of claim 12 wherein the plasticizing solvent is selected from the group consisting of dimethoxy ethyl phthalate, triacetin, polyethylene glycol, triethylene glycol diactetate, diethylene glycol diacetate, diethylene glycol dipropionate, dethylene glycol acetate propionate, diethylene glycol monopropionate, and mixtures thereof

15. The method of claim 12 wherein the step of exposing the aggregation of cellulose ester fibers to a plasticizing solvent comprises spraying, dipping, brushing, or a combination thereof.

16. The method of claim 12 wherein the cellulose ester-containing substrate is a paper.

17. The method of claim 16 wherein the step of contacting the aggregation of cellulose ester fibers with a substrate comprises wrapping the aggregation of cellulose ester fibers with the substrate.

18. The method of claim 17 wherein the filter is a cigarette filter.

19. The method of claim 12 wherein the cellulose ester-containing substrate comprises a component selected from the group consisting of cellulose acetate, cellulose propionate, cellulose butyrate, cellulose acetate-propionate, cellulose acetate-butyrate, cellulose propionate-butyrate, and mixtures thereof.

20. The method of claim 12 wherein the cellulose ester-containing substrate comprises cellulose acetate.

21. The method of claim 12 wherein the cellulose ester fibers comprise cellulose acetate.

22. A filter comprising:
an aggregation of cellulose ester fibers;
a cellulose ester-containing substrate disposed over the aggregation of cellulose ester fibers; and
a solvent bond between the aggregation of cellulose ester fibers and the cellulose ester-containing substrate that adheres the aggregation of cellulose ester fibers and the cellulose ester-containing substrate together.

23. The filter of claim 22 where the solvent bond is formed by evaporating a solvent applied to one or both of the aggregation of cellulose ester fibers or the cellulose ester-containing substrate.

24. The filter of claim 22 where the solvent bond is formed by absorbing a solvent into one or both of a surface of the aggregation of cellulose ester fibers or a surface of the cellulose ester-containing substrate.

25. The filter of claim 22 wherein the cellulose ester fibers comprise cellulose acetate.

26. The filter of claim 22 wherein the cellulose ester-containing substrate comprises a component selected from the group consisting of cellulose acetate, cellulose propionate, cellulose butyrate, cellulose acetate-propionate, cellulose acetate-butyrate, cellulose propionate-butyrate, and mixtures thereof.

27. The filter of claim 22 wherein the cellulose ester-containing substrate is a paper.

28. The filter of claim 22 wherein the cellulose ester-containing substrate comprises cellulose acetate.

29. The filter of claim 28 wherein the cellulose ester-containing substrate further comprises cellulose.

30. The filter of claim 25 that is a cigarette filter, and wherein the cellulose ester-containing substrate is a paper comprising cellulose acetate and cellulose.

31. A method of attaching a headliner to a vehicle passenger compartment ceiling, the headliner having a surface layer with cellulose acetate fibers incorporated therein, the method comprising:
a) applying a cellulose ester-containing composition to the vehicle compartment ceiling to form a coated vehicle compartment ceiling;
b) exposing at least one of the surface layer or the coated vehicle compartment ceiling to a plasticizing solvent;
c) contacting the surface layer and the coated vehicle compartment ceiling together to form a compound headliner-ceiling structure; and
d) curing the compound headliner-ceiling structure so that the surface layer and the coated vehicle compartment ceiling become adhered together.

32. The method of claim 31 wherein the cellulose ester fibers comprise a component selected from the group consisting of cellulose acetate, cellulose propionate, cellulose butyrate, cellulose acetate-propionate, cellulose acetate-butyrate, cellulose propionate-butyrate, and mixtures thereof.

33. The method of claim 31 wherein the cellulose ester-containing composition independently comprise a component selected from the group consisting of cellulose acetate, cellulose propionate, cellulose butyrate, cellulose acetate-propionate, cellulose acetate-butyrate, cellulose propionate-butyrate, and mixtures thereof.

34. The method of claim 31 wherein the cellulose ester fibers comprise cellulose acetate and the cellulose ester-containing composition comprises cellulose acetate.

35. A headliner made according to the method of claim 31.
